(19) United States
(12) Patent Application Publication
(10) Pub. No.: US 2006/0224619 A1
(43) Pub. Date: Oct. 5, 2006

(54) System for providing media service using sensor network and metadata

(75) Inventors: Jeong Hoon Kang, Seoul (KR); Byeong Ho Choi, Yongin (KR); Byung Ha Park, Seoul (KR); Je Woo Kim, Seoul (KR); Min Goo Lee, Yongin (KR)

Correspondence Address: SUGHRUE MION, PLLC, 2100 PENNSYLVANIA AVENUE, N.W., SUITE 800, WASHINGTON, DC, 20037, US

(73) Assignee: Korea Electronics Technology Institute

(21) Appl. No.: 11/182,950

(22) Filed: Jul. 18, 2005

(30) Foreign Application Priority Data
Mar. 30, 2005 (KR) 10-2005-0026403

(51) Int. Cl. G06F 17/00

(52) U.S. Cl. 707/103 X

(57) ABSTRACT

Disclosed herein is a system for providing media service using a sensor network and metadata. The sensor network includes a plurality of sensor network nodes connected to a media server and one or more media devices, respectively. The media server includes a media information storage unit, a sensor interface unit, a metadata storage unit, a content selection unit and a content transmission unit. The media device includes a content reception unit, a sensor interface unit and a metadata storage unit. The sensor network nodes each include a network interface unit, a device interface unit and a metadata storage unit. In detail, the metadata are input to the corresponding sensor network node, media content desired by a user is intelligently retrieved based on the metadata, and the media content desired by the user is provided to the media device desired by the user, including a mobile media device in the user's possession, at a time desired by the user.

### RELATED APPLICATIONS

The present disclosure relates to subject matter contained in priority Korean Application No. 10-2005-0026403, filed on 30 Mar. 2005, which is herein expressly incorporated by reference in its entirety.

### BACKGROUND OF THE INVENTION

1. Field of the Invention

The present invention relates generally to a system for providing media service using a sensor network and metadata and, more particularly, to a system for providing media service using a sensor network and metadata, in which metadata are input to a sensor network node, media content desired by a user is intelligently retrieved based on the metadata, and the media content desired by the user is provided to a media device desired by the user, including a mobile media device in the user's possession, at a time desired by the user.

2. Description of the Related Art

As broadcasting and communication converge and broadcasting is digitized, a broadcasting environment assumes a complicated form that accommodates the operation of networks in conjunction with heterogeneous networks, unlike existing single directional reception, and various devices as well as multiple media and multiple channels.

In the above-described environment, a large amount of high-quality broadcast content is expected to be provided through broadcasting and communication in a multiple media and multiple channel broadcasting environment, the type of broadcast content varies from video-oriented content to multimedia content that includes images, text and graphics, and the provision of new types of media content, such as application software, games and web pages, is being taken into account. In particular, the provision of interactive content, in which various types of individual content organically converge, is also expected (hereinafter the broadcast content, the multimedia content, the media content, and the interactive content are collectively called “media content”). Furthermore, a new broadcasting and communication convergence environment, in which a variety of media content is provided and used through the operation of broadcasting networks, such as a terrestrial broadcasting network, a satellite broadcasting network, a digital cable broadcasting network and a Digital Multimedia Broadcasting (DMB) network, in conjunction with the various heterogeneous networks, such as the Internet, a mobile communication network, a portable Internet and a Wireless Local Area Network (WLAN), is being developed and popularized.

Under the above-described broadcasting and communication environment, a user may encounter the media content through various networks using various media devices (TeleVision (TV), a Personal Computer (PC), a mobile phone, a Personal Digital Assistant (PDA) and a DMB device).

Many technologies regarding a scheme for providing media content desired by users have been developed and are being practically used to meet variation in the broadcasting and communication convergence environment and market demand. In particular, for example, a Personal Video Recorder (PVR) has been developed and is being practically used in order to store media content and provide it to a user at a time desired by the user.

In particular, in the case of the broadcasting environment, technology using the TV-Anytime standard is being developed so that media content desired by a user can be conveniently and effectively used in a form desired by the user at a time desired by the user in conformity with the user's preference using various devices, regardless of location. In the TV-Anytime standard, metadata are used to describe the details and usage environment of the media content.

In the conventional broadcasting environment, technology for providing media content desired by a user is at the level of providing broadcast on demand that is suitable for a user using data broadcasting metadata. Furthermore, the technology, which uses the existing metadata for data broadcasting, is inconvenient in that the user's new metadata information must be personally input for a new media device. That is, in order to be provided with the broadcast on demand by purchasing a new Portable Mutimedia Player (PMP) and using it, the user must input and set information about his or her preferred genre and watching time. Furthermore, the technology is problematic in that updating the media content based on the metadata is impossible because the corresponding metadata cannot be exchanged when the power of the media device is turned off.

Furthermore, viewing the media content that is retrieved and stored using the technology, for example, a broadcast program that is stored on the PVR, through scheduled recording is the same as viewing a broadcast program that is stored on a storage device, such as a hard disk, using the corresponding PVR. Accordingly, it is disadvantageous in that the user may consume the retrieved and stored media content only through the media device that performed the retrieval and storage of the corresponding media content.

Meanwhile, a sensor network has the concept of operating in conjunction with a network, and performing management and control in real time while monitoring the presence and locations of objects by adding a network concept to a sensor. In particular, the sensor network is newly attracting attention in relation to ubiquitous computing. A Ubiquitous Sensor Network (USN) is a network that is configured to wirelessly collect information sensed by various types of sensors. With the development of a Wireless Personal Area Network (WPAN) and ad-hoc network technology, USN-related technology is being developed and popularized.

In relation to a ubiquitous computing environment, it is expected that the number of objects to which the sensor network is applied will increase.

However, technology providing supplementary service, by merging technology related to the retrieval, storage and provision of media content using metadata with technology that collects and processes various types of information using the sensor network, has not been sufficiently developed.

Under the above-described conditions, even when the mobile media device that can operate in a mobile environment, such as the media device in the user's possession, for example, a PDA or a PMP, is turned off, a sensor node within the mobile media device is used and exchanges metadata with the sensor nodes of other mobile media devices included in the sensor network, so that the necessity for technology, in which the mobile media device can be updated with information about the most recent environment, and a user who is located in a certain place, such as a home or an office, can be provided with uninterrupted media service regardless of time, location or media device performance, is increasing.

### SUMMARY OF THE INVENTION

Accordingly, the present invention has been made keeping in mind the above problems occurring in the prior art, and an object of the present invention is to provide a system for providing media service using a sensor network and metadata, in which metadata are input to a sensor network node, and media content desired by a user is intelligently retrieved based on the metadata, and the media content desired by the user is provided to a media device desired by the user, including a mobile media device in the user's possession, at a time desired by the user.

Furthermore, another object of the present invention is to provide a media sever and media device for applying to the system for providing media service using a sensor network and metadata.

In order to accomplish the above object, the present invention provides a system for providing media service using a sensor network and metadata, the sensor network having a plurality of sensor network nodes connected to a media server and one or more media devices, respectively, wherein: the media server comprises a media information storage unit for storing media information about the locations and details of media content, a sensor interface unit for providing interface with a corresponding sensor network node, which is connected to the media server, for the transmission and reception of data, a metadata storage unit for storing metadata about a user's preference information and the media devices, receiving the metadata from the media devices through the sensor interface unit, comparing previously stored metadata with the received metadata, and storing updated metadata, a content selection unit for retrieving the media information from the media information storage unit using the metadata stored in the metadata storage unit, and selecting media content to be transmitted to the media devices, and a content transmission unit for transmitting the selected media content to the media devices; the media devices each comprise a content reception unit for receiving the media content transmitted from the content transmission unit of the media server, a sensor interface unit for providing interface with a corresponding sensor network node, which is connected to the media devices, for the transmission and reception of data, and a metadata storage unit for storing the metadata about the user's preference information and the media devices, receiving the metadata from the media server through the sensor interface unit, comparing previously stored metadata with the received metadata and storing updated metadata; and the sensor network nodes each comprise a sensor network interface unit for providing interface with sensor network nodes of other devices, which exist within the media service providing system, for the transmission and reception of data, a device interface unit for providing interface with a corresponding media device for the transmission and reception of data, and a metadata storage unit for receiving metadata from the corresponding media device through the device interface unit and storing the metadata, and receiving the metadata from other sensor network nodes through the sensor network interface unit, comparing previously stored metadata with the received metadata and storing updated metadata.

In the system for providing media service using a sensor network and metadata, it is preferred that the media server further comprise a transcoding unit for transcoding the media content, selected by the content selection unit, in conformity with the media devices, and the content transmission unit transmit the media content, transcoded by the transcoding unit, to the media devices.

In the system for providing media service using a sensor network and metadata, it is preferred that the sensor network nodes each further comprise a device power control unit for controlling power of the corresponding device, and the device power control unit controls the corresponding device so that power of the corresponding device is automatically turned on based on the metadata about the user's preference information.

In the system for providing media service using a sensor network and metadata, it is preferred that the metadata be included in and transmitted through data packets transmitted between the sensor network nodes.

In the system for providing media service using a sensor network and metadata, it is preferred that the media devices include one or more mobile devices, such as a notebook computer, a PDA, a tablet PC and a PMP.

In the system for providing media service using a sensor network and metadata, it is preferred that the media devices be connected to the media server and receive the media content using a wired data transmission standard, such as a Universal Serial Bus (USB) standard, a Recommended Standard (RS)-232C standard, a coaxial cable standard, or an Institute of Electrical or Electronics Engineers (IEEE) 1394 standard.

In the system for providing media service using a sensor network and metadata, it is preferred that the media devices be connected to a media server and receive the media content using a wireless data transmission standard, such as a WLAN standard, a bluetooth standard or a Wireless Broadband (Wibro) standard.

In the system for providing media service using a sensor network and metadata, it is preferred that the metadata storage unit of the media server automatically recognize the media devices, and automatically generate and store metadata about the media devices.

In the system for providing media service using a sensor network and metadata, it is preferred that the transcoding unit of the media server transcode the media content in consideration of a data transmission rate supported at a time of performing transmission using the wireless data transmission standard.

In the system for providing media service using a sensor network and metadata, it is preferred that the media information storage unit of the media server store digital broadcasting Electronic Program Guide (EPG) data as the media information.

In the system for providing media service using a sensor network and metadata, it is preferred that the media information storage unit of the media server stores brief information about locations and details of the media content on the Internet as the media information.

In the system for providing media service using a sensor network and metadata, it is preferred that a wireless Access Point (AP) for transmitting the media content using a wireless data transmission standard be further included.

In the system for providing media service using a sensor network and metadata, it is preferred that the sensor network node is connected to the media server in a wired manner using a USB standard, an RS-232C standard, or an IEEE 1394 standard.

In the system for providing media service using a sensor network and metadata, it is preferred that the sensor network node connected to the media server be integrated with and contained in the media server.

In the system for providing media service using a sensor network and metadata, it is preferred that the sensor network nodes be connected to the media devices in a wired manner using a USB standard, an RS-232C standard, or an IEEE 1394 standard.

In the system for providing media service using a sensor network and metadata, it is preferred that the sensor network nodes connected to the media devices be integrated with and contained in the media device.

In addition, the present invention provides a media server used in a system for providing media service, the system having a media server configured to provide media content, one or more media devices configured to receive the media content and sensor network nodes connected to the media server and the media devices, respectively, and configured to store metadata including a user's preference information and media device information, the media server including a media information storage unit for storing media information including information about the locations and details of the media content; a sensor interface unit for providing interface with the sensor network node, which is connected to the media server, for the transmission and reception of data; a metadata storage unit for storing metadata about the user's preference information and the media devices, receiving the metadata from the sensor network nodes connected to the media devices, respectively, comparing previously stored metadata with the received metadata, and storing updated metadata; a content selection unit for retrieving the media information from the media information storage unit using the metadata stored in the metadata storage unit, and selecting media content to be transmitted to the media devices; and a content transmission unit for transmitting the media content, which is selected by the content selection unit, to the media devices.

In the media server according the present invention, it is preferred that a transcoding unit for transcoding the media content, selected by the content selection unit, in conformity with the media devices be further included; wherein the content transmission unit transmits the media content, transcoded by the transcoding unit, to the media devices.

In the media server according the present invention, it is preferred that the content transmission unit transmit the media content to the media devices using a wired data transmission standard, such as a USB standard, an RS-232C standard, a coaxial cable standard, or an IEEE 1394 standard.

In the media server according the present invention, it is preferred that the content transmission unit transmit the media content to the media devices using a wireless data transmission standard, such as a WLAN standard, a Bluetooth standard, or a Wireless Broadband (Wibro) standard.

In the media server according the present invention, it is preferred that the media information storage unit store digital broadcasting EPG data as the media information.

In the media server according the present invention, it is preferred that the media information storage unit store brief information about locations and details of the media content on the Internet as the media information.

In the media server according the present invention, it is preferred that the sensor network node connected to the media server be connected in a wired manner using a USB standard, an RS-232C standard, or an IEEE 1394 standard.

In the media server according the present invention, it is preferred that the sensor network node connected to the media server be integrated with and contained in the media server.

In the media server according the present invention, it is preferred that the media server be contained in a set-top box for receiving broadcasting in a single body.

In addition, the present invention provides a media device used in a system for providing media service, the system having a media server configured to provide media content, one or more media devices configured to receive the media content and sensor network nodes connected to the media server and the media devices, respectively, and configured to store metadata including a user's preference information and media device information, the media server including: a content reception unit for receiving media content from the media server; a sensor interface unit for providing interface with a sensor network node, which is connected to the media device, for the transmission and reception of data; and a metadata storage unit for storing metadata about the user's preference information and the media device, receiving the meta data through the sensor interface unit, comparing previously stored metadata with the received data, and storing updated metadata.

In the media device according the present invention, it is preferred that the media device be controlled by the sensor network node connected to the media device, so that power of the corresponding device automatically is turned on.

In the media device according the present invention, it is preferred that the media devices include one or more mobile media devices, such as notebook computer, a PDA, a tablet PC and a PMP.

In the media device according the present invention, it is preferred that the sensor network node be connected to the media device in a wired manner using a USB standard, an RS-232C standard, or an IEEE 1394 standard.

In the media device according the present invention, it is preferred that the sensor network node connected to the media device be integrated with and contained in the media device.

### SPECIFICATION DESCRIPTION OF THE DRAWINGS

The above and other objects, features and advantages of the present invention will be more clearly understood from the following detailed description taken in conjunction with the accompanying drawings, in which:

FIGS. 1a to 1c are block diagrams of a system for providing media service using a sensor network and metadata in accordance with to the present invention; and

FIG. 2 is a view showing a service providing environment for the system for providing media service using a sensor network and metadata in accordance with the present invention.

### DESCRIPTION OF THE PREFERRED EMBODIMENTS

A system for providing media service using a sensor network and metadata in accordance with to the present invention is described in detail with reference to the accompanying drawings below.

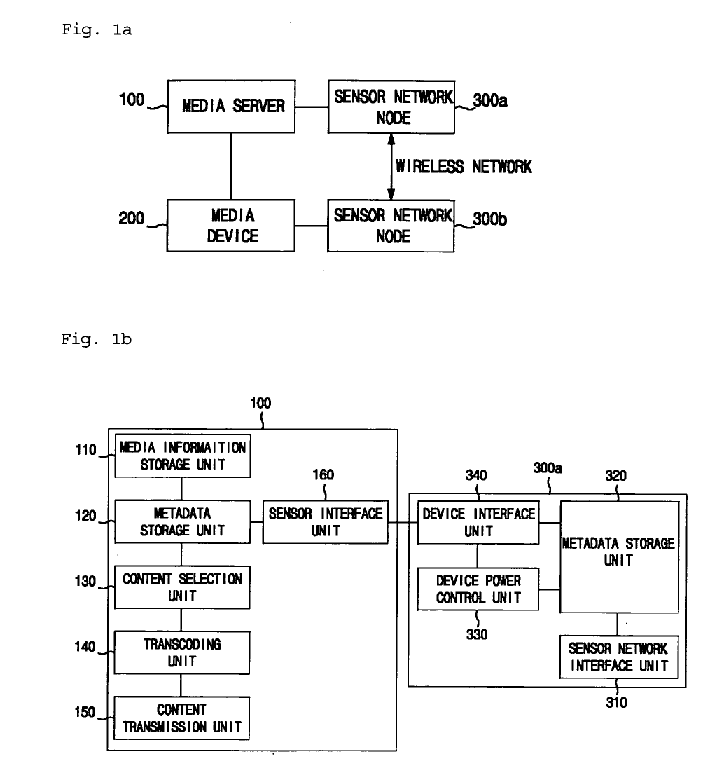

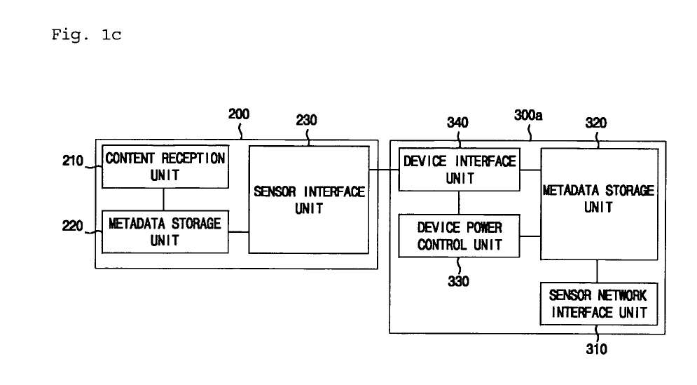

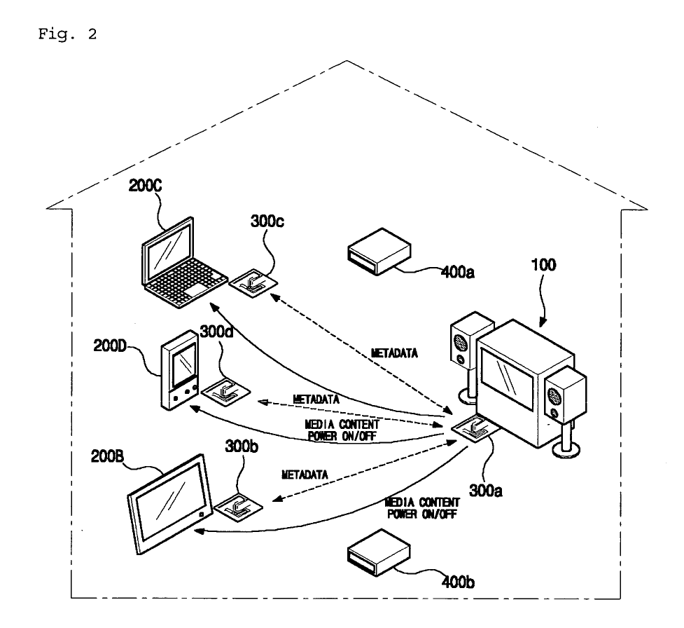

FIGS. 1a to 1c are block diagrams of the system for providing media service using a sensor network and metadata in accordance with the present invention, in which FIG. 1a is a block diagram of the system for providing media service using a sensor network and metadata in accordance with the present invention, FIG. 1b is a block diagram of a media server 100 and a sensor network node 300a in the system for providing media service using a sensor network and metadata in accordance with the present invention, and FIG. 3 is a block diagram of a media device 200 and a sensor network node 300b in the system for providing media service using a sensor network and metadata in accordance with the present invention.

With reference to FIGS. 1a to 1c, the system for providing media service using a sensor network and metadata in accordance with the present invention is described in detail.

As shown in the drawings, the system for providing media service using a sensor network and metadata in accordance with the present invention includes the media server 100, the media device 200, and the sensor network nodes 300a and 300b.

The media server 100 includes a media information storage unit 110, a metadata storage unit 120, a content selection unit 130, a content transmission unit 150 and a sensor interface unit 160. The media server 100 may further include a transcoding unit 140. Although the media server 100 may include components for receiving or reading media content, descriptions of the components are omitted because the components have no relation to the features of the system for providing media service in accordance with the present invention.

The media information storage unit 110 stores media information including information about the locations and details of media content. The media server 100 may directly store the media content in an information storage device, such as a hard disk. In this case, the storage location of the information storage device in which the corresponding media content has been stored, and brief information about the media content are stored as media information about the corresponding media content. Furthermore, in the case of digital broadcasting, EPG data, including information about the channel of the broadcast program currently being broadcast or to be broadcast, are stored as the media information. In contrast, in the case in which the media content is received through a network connection with the Internet, a corresponding Uniform Resource Locator (URL), and information about packets and content are stored as the media information. An example of the latter case is the provision of an Internet Protocol (IP)-TeleVision (TV) service that broadcasts a program over the Internet. The media content may be received through broadcasting, or may be acquired by reading media content stored on a data storage device, such as a Compact Disk (CD) or a Digital Video Disk (DVD), using the information that has been stored on the media information storage unit 110. Since details regarding the acquisition of the media content have no relation to the features of the present invention, detailed descriptions thereof are omitted.

The metadata storage unit 120 stores metadata. The metadata are data including information about the media content, the media devices within the system for providing media service in accordance with the present invention and a user's preference. The metadata are produced in the media server 100 or the media devices 200 by the user's input, and the automatic recognition of the information about the media devices 200. The produced metadata are transmitted to other media devices within the system for providing media service in accordance with the present invention or the media server 100, so that all the devices (the media server and the media devices) within the system for providing media service in accordance with the present invention are updated to store the same metadata.

The content selection unit 130 retrieves the media information, which is stored in the media information storage unit 110, using the metadata stored in the metadata storage unit 120, and selects a piece of media content to be transmitted to the media device 200. For example, in the case in which the media content is directly stored on the media information storage unit 110, the content selection unit 130 retrieves media content, which is desired by the user, using metadata corresponding to the information about the user's preference pertaining to the corresponding media content, and selects the retrieved data. In contrast, in the case in which EPG data are stored on the media information storage unit 110, the content selection unit 130 retrieves media content, which is desired by the user, by analyzing the details of the EPG data, receives the retrieved media content through a tuner, and selects the retrieved media content to be transmitted to the media device 200.

The content transmission unit 150 transmits the selected media content to the media device 200. When the media server 100 and the media device 200 are connected to each other using a wired network transmission standard, such as an USB standard, transmission is performed using the corresponding wired network transmission standard. In contrast, when the media server 100 and the media device 200 are connected to each other using a wireless network transmission standard, such as a WLAN standard, the transmission is performed using the corresponding wireless network transmission standard.

The sensor interface unit 160 provides interface with the sensor network node 300a for the transmission and reception of data. Information transmitted and received between the media server 100 and the sensor network 300a includes, for example, metadata, or control information for controlling the power of the media server 100.

The media server 100 according to the present invention may further include a transcoding unit 140. The transcoding unit 140 transcodes the media content selected by the content selection unit 130 in conformity with the media device 200 and a network environment used by the media device 200. The transcoding is performed in real time according to the specification of the media device 200, for example, the resolution of a display device of the media device 200, and the transmission rate of the network environment. Accordingly, the user can normally view his or her desired media content regardless of the specification of his or her own media device 200. When the transcoding unit 140 is included in the media server 100, the content transmission unit 150 transmits the selected and transcoded media content to the media device 200.

The sensor network node 300a is connected with the media server 100 to enable the transmission and reception of data. The connection between the media server 100 and the sensor network node 300a is set up using a standard, such as the USB standard, or is set up in such a way that the sensor network node 300a is contained in the media server 100.

The media server 100 may be implemented in such a way to be contained in a conventional set-top box for receiving broadcasting. For example, the media server 100 may be implemented in such a way to be contained in a digital terrestrial set-top box for receiving and processing broadcasting signals based on the Advanced Television system Committee (ATSC) standard, a digital cable broadcasting set-top box for receiving and processing broadcasting signals based on the Opencable standard, a satellite set-top box for receiving and processing satellite broadcasting signals based on the DVB, or an IP-TV set-top box for receiving and processing broadcasting signals based on the IP-TV standard that has recently been developed using an IP network.

The media device 200 includes a content reception unit 210, a metadata storage unit 220, and a sensor interface unit 220. Furthermore, although the media device 200 includes a codec for reproducing media content or a display device for displaying the media content, details thereof have no relation to the features of the system for providing media service in accordance with the present invention, so descriptions thereof are omitted.

The media device 200 according to the present invention refers to all the devices that can reproduce media content. For example, the concept of the media device 200 includes a TV that is connected with the media server 100 using a wired cable, and a notebook computer, a PDA, a tablet PC and a PMP that are connected with the media server 100 using a wired or wireless network standard. Particularly, in the present specification, a media device, such as a notebook computer, a PDA, a tablet PC, a PMP and a DMB receiver, to be used in a mobile environment is called a mobile media device.

The content reception unit 210 receives the media content transmitted from the content transmission unit 150 of the media server 100. The received media content is converted into a form suitable for display through the decoder of the media device 200, and is then provided to the user.

The metadata storage unit 220 stores the metadata. Since the metadata storage unit 220 has the same function as the metadata storage unit 220 of the media server 100, a detailed description thereof is omitted.

The sensor interface unit 230 provides interface with the sensor network node 300b for the transmission and reception of data. Information transmitted and received between the media server 200 and the sensor network 300b includes, for example, metadata, or control information for controlling the power of the media server 200.

Furthermore, the sensor network node 300b is connected to the media device 200 in a wired manner using a USB standard, or is contained in the media device 200.

The sensor network nodes 300a and 300b are devices configured to transmit and receive data using a sensor network standard, and each of the sensor network nodes 300a and 300b includes a sensor network interface 310, a metadata storage unit 320, a device power control unit 330, and a device interface unit 340.

The sensor network interface 310 transmits and receives data to and from the sensor network nodes of other devices in the system for providing media service in accordance with the present invention. For example, the sensor network node 300a connected to the media server 100 transmits and receives data to and from the sensor network node 300b connected to the media device 200 using a wireless sensor network standard, for example, the USN standard or the WPAN standard. In this case, the metadata may be included in and transmitted through data packets that are transmitted and received between the sensor network nodes 300a and 300b. The present invention is configured to transmit and receive the metadata via a sensor network, thus being capable of transmitting and receiving the metadata even when the power of the media server 100 or the media device 200 is turned off.

The metadata storage unit 320 receives and stores the metadata that are stored in a device to which the metadata storage unit 320 is connected. The reason why the metadata storage unit 320 is included is to enable the metadata to be updated by reading the stored metadata and transmitting the result of the reading to other devices through the sensor network even when the power of the device to which the metadata storage unit 320 has been connected is turned off. For example, when the sensor network node 300a is in the state of receiving and storing the metadata, which are stored in the media server 100, in advance, the sensor network node 300a can transmit the metadata to the media device 200 through the sensor network node 300b and update the existing metadata of the media device 200 even when the power of the media server 100 is turned off.

The device power control unit 330 causes a corresponding device to be turned on and be operated. For example, in the case of the sensor network node 300a, the power of the media server 100 is automatically turned on so that the media server 100 operates.

The device interface unit 340 provides interface with a device, to which the sensor network node is connected, the transmission and reception of data. For example, in the case of the sensor network node 300a, the device interface unit 340 transmits and receives data to and from the media server 100.

In accordance with the present invention, the sensor network nodes 300a and 300b are configured to be connected to the media server 100 and the media device 200, respectively, so that the sensor network node 300a can receive the metadata from the media server 100 and transmit the received metadata to the sensor network node 300b connected to the media device 200 and the sensor node 300b can transmit the metadata, which are received from the sensor node 300a, to the media device 200 in turn.

The metadata stored in the media device 200 can be transmitted to the media server 100 via the sensor network nodes 300b and 300a.

Furthermore, using the stored metadata, media content can be provided through the media device 200 desired by the user in the environment desired by the user.

For example, even when a broadcast program, which the user desires to view, is accidentally missed, the user can view the missed broadcast program in such a way as to automatically receive the broadcast program from the media server 100 and transmit it to the media device 200, for example, a TV or a notebook computer, using the metadata in which information on the broadcast program is stored. Furthermore, since the sensor network node can control the power of the media device 200, the power of the media device 200 is automatically turned on even when the power of the media device 200 is at a turned-off state and, thus, the broadcast program can be provided to the user. Furthermore, transcoding is performed depending on the specification of the media device 200 or a network environment, so that media content suitable for the user's environment can be provided.

FIG. 2 is a view showing the service providing environment of the system for providing media service using a sensor network and metadata in accordance with the present invention.

As shown in the drawing, a media server 100 and various types of media devices 200B, 200C and 200D are disposed in a certain space inside a home or an office. For example, assuming that the media server 100 and the various types of media devices 200B, 200C and 200D are disposed inside a home, the service providing environment of the system for providing media service is described below.

As examples of the media devices, the TV 200B, the notebook computer 200C, and the PDA 200D are illustrated in FIG. 2.

As shown in the drawing, sensor network nodes 300a, 300b, 300c and 300d are attached to and installed on the media server 100, and the media devices 200B, 200C and 200D, respectively.

The sensor network node 300a, 300b, 300c and 300d, which are attached to the media server 100 and the media devices 200B, 200C and 200D, respectively, are configured to transmit and receive metadata to and from each other through the wireless sensor network.

The media content is provided from the media server 100 to each of the media devices 200B, 200C and 200D using a wired data transmission standard when the media server 100 and the media devices 200B, 200C and 200D are connected to each other using the corresponding wired data transmission standard, and is provided using a wireless data transmission standard when the media server 100 and the media devices 200B, 200C and 200D are connected using the corresponding wireless data transmission standard.

For example, since the TV 200B is connected using a cable, it is provided with media content from the media server 100 via a cable.

Furthermore, the notebook computer 200C is provided with media content from the media server 100 using a USB standard when the notebook computer 200C is connected using a USB port, and is provided with media content using the WLAN standard when the notebook computer 200C is connected using the wireless data transmission standard, such as the WLAN standard.

When a media device receives the media content using the wireless data transmission standard, one or more wireless APs 400a and 400b are installed inside the home, and perform the transmission of the media content.

In the above-described environment, when the user views the media content using the media devices 200C and 200D to which the sensor network nodes 300c and 300d are attached, for example, when the user attempts scheduled recording of his or her desired media content, the corresponding media content is automatically stored in the media server 100 at a time desired by the user based on the user's scheduled recording request information. The scheduled recording is performed by wirelessly exchanging the metadata between the sensor network nodes 300a, 300b, 300c and 300d. Furthermore, the user can view the media content, which is scheduled and recorded by the media server, at a time desired by the user using the media devices 200B, 200C and 200D in the user's possession.

As described above, in accordance with the present invention, media content desired by a user is intelligently retrieved based on metadata input to the sensor network nodes, so that the media content desired by the user can be provided to the media device desired by the user, which includes the mobile media device in the user's possession, at a time desired by the user.

That is, when the present invention is applied, a user inside a home can timely record and store media content desired by the user without a separate operation, such as metadata input. Since the metadata can be exchanged between the low power sensor network nodes using wireless sensor network communication even when a media device desired by the user is turned off, energy consumption can be reduced in the case in which the media device is a mobile media device that can be used in a moving media device environment.

Furthermore, unlike the existing case, in which the media content is viewable only through the media device that has recorded the media content in a scheduled manner, the present invention enables the media content to be transmitted to the mobile device desired by the user through the wireless APs and to be viewed by the user. Since this allows service most suitable for a home environment to be provided regardless of the performance of the media device in the user's possession and a wireless network environment, improved media service can be provided. Furthermore, the installation cost of hardware is very low even at a time of implementation of the system of providing media service in accordance with the present invention, and the implementation of the system can be supported by software.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system for providing media service using a sensor network and metadata, the sensor network having a plurality of sensor network nodes connected to a media server and one or more media devices, respectively, wherein:
the media server comprises a media information storage unit for storing media information about locations and details of media content, a sensor interface unit for providing interface with a corresponding sensor network node, which is connected to the media server, for transmission and reception of data, a metadata storage unit for storing metadata about a user's preference information and the media devices, receiving the metadata from the media devices through the sensor interface unit, comparing previously stored metadata with the received metadata, and storing updated metadata, a content selection unit for retrieving the media information from the media information storage unit using the metadata stored in the metadata storage unit, and selecting media content to be transmitted to the media devices, and a content transmission unit for transmitting the selected media content to the media devices;
the media devices each comprise a content reception unit for receiving the media content transmitted from the content transmission unit of the media server, a sensor interface unit for providing interface with a corresponding sensor network node, which is connected to the media devices, for transmission and reception of data, and a metadata storage unit for storing the metadata about the user's preference information and the media devices, receiving the metadata from the media server through the sensor interface unit, comparing previously stored metadata with the received metadata and storing updated metadata; and
the sensor network nodes each comprise a sensor network interface unit for providing interface with sensor network nodes of other devices, which exist within the media service providing system, for transmission and reception of data, a device interface unit for providing interface with a corresponding media device for transmission and reception of data, and a metadata storage unit for receiving metadata from the corresponding media device through the device interface unit and storing the metadata, and receiving the metadata from other sensor network nodes through the sensor network interface unit, comparing previously stored metadata with the received metadata and storing updated metadata.

2. The system as set forth in claim 1, wherein:
the media server further comprises a transcoding unit for transcoding the media content, selected by the content selection unit, in conformity with the media devices; and
the content transmission unit transmits the media content, transcoded by the transcoding unit, to the media devices.

3. The system as set forth in claim 1, wherein:
the sensor network nodes each further comprise a device power control unit for controlling power of the corresponding device; and
the device power control unit controls the corresponding device so that power of the corresponding device is automatically turned on based on the metadata about the user's preference information.

4. The system as set forth in claim 1, wherein the metadata are included in and transmitted through data packets transmitted between the sensor network nodes.

5. The system as set forth in claim 1, wherein the media devices include one or more mobile devices, such as a notebook computer, a Personal Digital Assistant (PDA), a tablet Personal Computer (PC) and a Portable Media Player (PMP).

6. The system as set forth in claim 1, wherein the media devices are connected to the media server and receive the media content using a wired data transmission standard, such as a Universal Serial Bus (USB) standard, a Recommended Standard (RS)-232C standard, a coaxial cable standard, or an Institute of Electrical or Electronics Engineers (IEEE) 1394 standard.

7. The system as set forth in claim 1, wherein the media devices are connected to a media server and receive the media content using a wireless data transmission standard, such as a Wireless Local Area Network (WLAN) standard, a bluetooth standard or a Wireless Broadband (Wibro) standard.

8. The system as set forth in claim 1, wherein the metadata storage unit of the media server automatically recognizes the media devices, and automatically generates and stores metadata about the media devices.

9. The system as set forth in claim 7, wherein the transcoding unit of the media server transcodes the media content in consideration of a data transmission rate supported at a time of performing transmission using the wireless data transmission standard.

10. The system as set forth in claim 1, wherein the media information storage unit of the media server stores digital broadcasting Electronic Program Guide (EPG) data as the media information.

11. The system as set forth in claim 1, wherein the media information storage unit of the media server stores brief information about locations and details of the media content on the Internet as the media information.

12. The system as set forth in claim 6, further comprising a wireless Access Point (AP) for transmitting the media content using a wireless data transmission standard.

13. The system as set forth in any one of claims 1 to 12, wherein the sensor network node is connected to the media server in a wired manner using a USB standard, an RS-232C standard, or an IEEE 1394 standard.

14. The system as set forth in any one of claims 1 to 12, wherein the sensor network node connected to the media server is integrated with and contained in the media server.

15. The system as set forth in claim any one of claims 1 to 12, wherein the sensor network nodes are connected to the media devices in a wired manner using a USB standard, an RS-232C standard, or an IEEE 1394 standard.

16. The system as set forth in claim any one of claims 1 to 12, wherein the sensor network nodes connected to the media devices is integrated with and contained in the media device.

17. A media server used in a system for providing media service, the system having a media server configured to provide media content, one or more media devices configured to receive the media content and sensor network nodes connected to the media server and the media devices, respectively, and configured to store metadata including a user's preference information and media device information, the media server comprising:
a media information storage unit for storing media information including information about locations and details of the media content;
a sensor interface unit for providing interface with the sensor network node, which is connected to the media server, for transmission and reception of data;
a metadata storage unit for storing metadata about the user's preference information and the media devices, receiving the metadata from the sensor network nodes connected to the media devices, respectively, comparing previously stored metadata with the received metadata, and storing updated metadata;
a content selection unit for retrieving the media information from the media information storage unit using the metadata stored in the metadata storage unit, and selecting media content to be transmitted to the media devices; and
a content transmission unit for transmitting the media content, which is selected by the content selection unit, to the media devices.

18. The media server as set forth in claim 17, further comprising a transcoding unit for transcoding the media content, selected by the content selection unit, in conformity with the media devices;
wherein the content transmission unit transmits the media content, transcoded by the transcoding unit, to the media devices.

19. The media server as set forth in claim 17, wherein the content transmission unit transmits the media content to the media devices using a wired data transmission standard, such as a USB standard, an RS-232C standard, a coaxial cable standard, or an IEEE 1394 standard.

20. The media server as set forth in claim 17, wherein the content transmission unit transmits the media content to the media devices using a wireless data transmission standard, such as a WLAN standard, a Bluetooth standard, or a Wibro standard.

21. The media server as set forth in claim 17, wherein the media information storage unit stores digital broadcasting EPG data as the media information.

22. The media server as set forth in claim 17, wherein the media information storage unit stores brief information about locations and details of the media content on the Internet as the media information.

23. The media server as set forth in any one of claims 17 to 22, wherein the sensor network node connected to the media server is connected in a wired manner using a USB standard, an RS-232C standard, or an IEEE 1394 standard.

24. The media server as set forth in any one of claims 17 to 22, wherein the sensor network node connected to the media server is integrated with and contained in the media server.

25. The media server as set forth in any one of claims 17 to 22, wherein the media server is contained in a set-top box for receiving broadcasting in a single body.

26. A media device used in a system for providing media service, the system having a media server configured to provide media content, one or more media devices configured to receive the media content and sensor network nodes connected to the media server and the media devices, respectively, and configured to store metadata including a user's preference information and media device information, the media server comprising:
a content reception unit for receiving media content from the media server;
a sensor interface unit for providing interface with a sensor network node, which is connected to the media device, for transmission and reception of data; and
a metadata storage unit for storing metadata about the user's preference information and the media device, receiving the meta data through the sensor interface unit, comparing previously stored metadata with the received data, and storing updated metadata.

27. The media device as set forth in claim 26, the media device is controlled by the sensor network node connected to the media device, so that power of the corresponding device automatically is turned on.

28. The media device as set forth in claim 26, wherein the media devices includes one or more mobile media devices, such as notebook computer, a PDA, a tablet PC and a PMP.

29. The media device as set forth in any one of claims 26 to 28, wherein the sensor network node is connected to the media device in a wired manner using a USB standard, an RS-232C standard, or an IEEE 1394 standard.

30. The media device as set forth in any one of claims 26 to 28, wherein the sensor network node connected to the media device is integrated with and contained in the media device.
